(19) United States
(12) Patent Application Publication
(10) Pub. No.: US 2018/0111256 A1
(43) Pub. Date: Apr. 26, 2018

(54) ANCHOR WALL EXTRACTING DEVICE

(71) Applicant: Kristopher John Moreno, Sunnyvale, CA (US)

(72) Inventor: Kristopher John Moreno, Sunnyvale, CA (US)

(21) Appl. No.: 15/332,541

(22) Filed: Oct. 24, 2016

(51) Int. Cl. B25B 31/00; B25B 7/02

(52) U.S. Cl. CPC B25B 31/00; B25B 7/02

(57) ABSTRACT

A device for extracting wall anchors having a pair of handle portions and a pair of nose portions. The first nose portion having at least a bite implement disposed at a proximate tip of the first nose portion. A concaved portion of the bite implement is operable for clamping on a rim portion of the wall anchor to be removed. The second nose portion has at least a spiral groove implement, wherein the spiral groove implement is operable for mating with an inside thread of the wall anchor so that the wall anchor can be pulled out of the wall, and wherein the first nose portion is substantially shorter than said second nose portion to allow a portion of the tip of the first nose portion to be inserted into the inside thread of the wall anchor.

### CROSS- REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to hand tools. More particularly, certain embodiments of the invention relate to a sheetrock anchor extracting tool.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. When hanging items on a wall, some applications may require the use of an anchor to help support the weight of the hanging items. The need for such anchors may be greater when hanging items on walls made of a porous or brittle material such as, but not limited to, drywall, masonry, stucco, hollow walls, etc. There are multiple types of such anchors available including, without limitation, plastic inserts, metal anchors, hollow anchors, screw type anchors, toggle type anchors, expansion anchors, etc. Once installed, wall anchors typically do not have any instruction on how to remove them. Individuals may use general tools, not made for removing anchors such as, but not limited to, pliers, needle nose pliers, screwdrivers, scratch awls, hammers, picks, drills, channel locks, etc. It is believed that these tools typically do not have features to consistently remove anchors from walls and therefore may not easily or efficiently do so. Furthermore, it may be unsafe to use tools for tasks other than their intended use. Some anchors may have an integrated Phillips screwdriver slot that may be used to install and remove the anchor with a screwdriver. However, this slot may sometimes be stripped during installation, which may make removal with a screwdriver difficult or impossible.

By way of educational background, an aspect of the related technology generally useful to be aware of is that there is currently available a tool for collapsing hollow-wall anchors that may remove an anchor by pressing inward against the female threads within the anchor or by using the actual screw that came with the anchor. It was believed that the tool for collapsing hallow-wall anchors grasps on the outside outer edges of hollow anchor, and by squeezing the handles together it would actually un-collapse the set anchor by pushing the screw inward thus straightening hollow-wall anchor for removal. It is believed that this tool “the tool for collapsing hollow wall anchors” may only be used for removing hollow anchors.

It is the case that the tool for collapsing hallow-wall anchors is a tool for contractors to use for the INSTALL of lots of one style sheetrock anchors (hollow wall anchors) in a short amount of time, and the said tool it is not made to remove sheetrock anchors nor does so.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic side view of an exemplary wall anchor removal tool, in accordance with an embodiment of the present invention;

FIG. 2 is a diagrammatic side view of an exemplary wall anchor removal tool, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit —“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction with, some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a tool designed to remove wall anchors in interior and exterior settings from various surfaces including, without limitation, gypsum board, wood paneling, concrete, stucco, plaster, masonry, etc. Some embodiments may be able to remove multiple types of common sheetrock anchors such as, but not limited to, hollow wall drive anchors, ribbed or non-ribbed conical plastic or vinyl anchors, twist and lock style/ self-drilling anchors (plastic, vinyl or metal), toggle hollow wall anchor nylon, wallclaw anchors hammer in drywall anchors, crl (various sized) screw wall grabber anchors, fastcap rocloc drywall fastener hanger, lead wood screw anchors, drill toggle anchors, etc. Since they are designed to remove wall anchors, some embodiments may be able to remove such anchors easily and efficiently. In addition, the use of some embodiments may remove anchors more safely than other methods since the use of improper tools may be avoided.

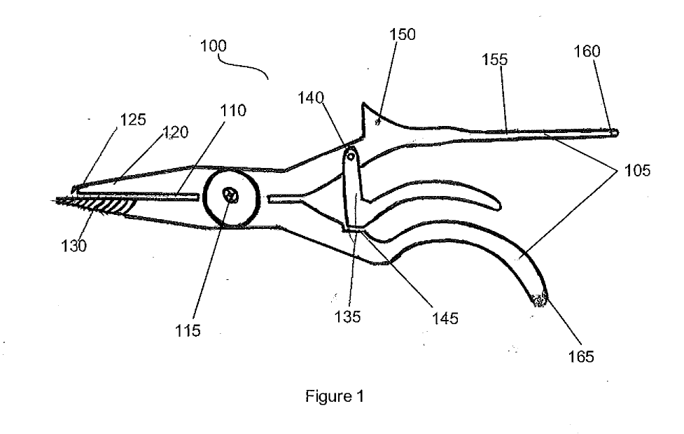

FIG. 1 is a diagrammatic side view of an exemplary wall anchor removal tool 100, in accordance with an embodiment of the present invention. In the present embodiment, anchor removal tool 100 may look similar to a pair of modified needle nose pliers with handles 105 and a nose portion 110 which may open and close around a pivot point 115. One section of nose portion 110 may comprise a shortened end 120 with a bite 125 near the tip. Bite 125 may be created by a groove cut or formed into the inside edge of shortened end 120 perpendicular to the tip. Bite 125 may be able to get between the anchor and the wall to grasp the edge of some types of anchors to help pull these anchors from the wall. Bite 125 may be approximately 1/32 of an inch deep cutout opening of the grove and form an approximate angle of around 45 degrees. It is contemplated that some embodiments may comprise deeper or shallower bites formed with various different angles depending on various factors such as, but not limited to, the size of the tool, the types and sizes of anchors being removed, the type of surface from which the anchor is being removed, etc. In the present embodiment, the other section of nose portion 110 may comprise left handed threading spiral groove 130 at the tip. Left handed treads are for the removal of twist and turn style sheetrock anchors stripped or not. Because the twist and turn anchors are right hand turn installed, this left hand turn spiral grooved tip 130 complimenting nose end 110, will be used as if one would be left hand turning a screwdriver. (Though it is rare) As a variation of the tool, a right hand thread spiral tip can assist in the left hand turn hardware installments. Threading 130 may be about 1/16 of an inch in depth and may extend from the tip towards handles 105 for about three quarters of an inch to an inch. Again, the dimensions of this threading may vary in some embodiments. In alternative embodiments, the spiral groove tip may comprise of a clockwise spiral grooved threads. In complimenting embodiments, the spiral groove tip may comprise of counter-clockwise spiral grooved threads.

In the present embodiment, a limiter 135 may be located behind pivot point 115 and may help prevent the sections of nose portion 110 from closing completely. For example, without limitation, limiter 135 may maintain about a 3/64-inch gap between the sections of nose portion 110. It is contemplated that the gap maintained by the limiter may be larger or smaller in some alternate embodiments. In the present embodiment, limiter 135 may pivot on a pin 140 to be moved into and out of place. When in place, limiter 135 may rest on a flattened surface 145 on one of handles 105. Limiter 135 may help release twist and lock style wall anchors or other types of stubborn anchors from removal tool 100 once the anchor is removed from the wall. This method of releasing an anchor using limiter 135 will be described below. It is contemplated that some embodiments may be implemented without a limiter 135, because the limiter 135 would not be needed.

In the present embodiment, one of the handles 105 may comprise a hammer/hand plate 150 and a probe 155 with a domed tip 160. Probe 160 may be inserted into a hollow style wall anchor to straighten the anchor if needed. Probe 155 may tapper off of hammer/hand plate 150 and maintain a cylindrical shape until domed tip 160. In some embodiments the probe 155 may end with a blunt or sharply pointed tip rather than a domed tip 160. In the present embodiment, to accommodate the width and depth of various wall anchors, which may range from about 3/32 of an inch to ¼ of an in in width, probe 155 may be about 9/64 of an inch in diameter and approximately 2.25 inches to 2.75 inches long to accommodate the smaller lighter duty anchors ranging from 3/32 to ⅛ inches in diameter, or 7/32 inches in diameter and approximately 2.25 inches to 2.75 inches long to accommodate the larger more heavy duty anchors ranging from 3/16 to ¼ inches in diameter. Some embodiments may have probes of various different sizes. In the present embodiment, hammer/hand plate 150 may protrude an inch and a half or two inches from handle 105 to allow for a hammer or a hand to strike plate 150. Hammer/hand plate 150 may be oval or rounded in shape. In some alternate embodiments, the hammer/hand plate may be shaped in various different configurations including, without limitation, square or rectangular shapes. In the present embodiment, an outside edge of hammer/hand plate 150 may be indented to capture a screw head, which may aid in the pushing in of the screw within a hollow style wall anchor if that screw remains in the anchor. With the indention on the hammer plate 150, place the indention 150 over the screw head and apply pressure pushing the tool and the screw inward through the anchor to straighten the hollow wall style anchor. Probe 155 may be strong enough to withstand slight hammering against hammer/hand plate 150 if needed. However, since hollow wall anchors are often made of soft metal that can be manipulated easily, the user may use hand pressure to straighten the anchor in some cases so that hammering may not be necessary. In some applications, hammer/hand plate 150 may double as a hand or finger rest. Those skilled in the art will readily recognize, in light of and in accordance with the teachings of the present invention, that some embodiments may be implemented without a hammer/and plate or a probe.

In the present embodiment, the end of the other handle 105 may comprise course grit 165, which may enable a user to ream the holes left by anchors in various materials including, without limitation, drywall after the extraction of the anchors. This may help with the refinishing of the wall. One exemplary configuration for coarse grit 165 may be to cover the last half inch of handle 105 with many small 3 or 4 or 5 sided pyramids, which may be positioned in a way that when twisting tool 100 into different positions course grit 165 may still be effective at reaming. It is contemplated that a multiplicity of suitable textures may be used in alternate embodiments to create the course grit on the end of the handle such as, but not limited to, knurled surfaces or irregular abrasive surfaces. In the present embodiment, tool 100 may be made of a durable material such as, but not limited to, cast iron, stainless steel, a mixture of carbon and steel, etc. In some embodiments the tool may comprise a vinyl dipped handle or other types of coatings for added grip. Other embodiments may comprise plastic handles which may or may not have an ergonomic design.

In typical use of the present embodiment, tool 100 may be used in different ways to remove various different types of wall anchors. Tool 100 may be used to remove wall anchors by use of probing, gripping, prying, pricking, protruding and extracting, etc. with a single hand in motion. For example, without limitation, tool 100 may be used to remove anchors that have an integrated Philips™ screwdriver slot by inserting nose portion 110 including threading 130 with a counterclockwise motion to penetrate the Phillips™ screwdriver slot even if the slot is stripped. As tool 100 enters the anchor in a counterclockwise manner, threading may grab the anchor so that it may be pulled from the wall.

In another non-limiting example, tool 100 may be used to remove a twist and lock type wall anchor. In this application limiter 135 may be engaged to help release the anchor from tool 100 after removal. Once limiter 135 is in place, nose portion 110 may be inserted into the hole of the anchor. Then tool 100 may be turned in a counterclockwise direction until threading 130 bonds to the anchor removing it. Once the anchor is out of the wall and on tool 100, limiter may be disengaged to enable the sections of nose portion 110 to completely close to create room between the anchor and tool 100, which may typically enable the anchor to release from tool 100. Without limiter 135 it is believed that tools may be needed to remove twist and lock style anchors since the anchor may be bonded too tightly to tool 100. Also, a user may cut his/her hands on the anchor if he attempts to remove such an anchor from tool 100 with his/her bare hands.

Furthermore, tool 100 may be used as a pinch and pull prying tool using concaved bite 125. By inserting the section of nose portion 110 with threading 130 inside a wall anchor up to the point where bite 125 of the opposite section of nose portion 110 can be pressed between the rim of the anchor and the wall. Then, with the anchor pinched within bite 125 and the threaded section of nose portion 110, the anchor may be pulled from the wall. If the anchor is painted over and/or stubborn, the anchor may be removed by engaging limiter 135 and inserting the full nose portion 110 into the anchor and twisting to engage and remove the anchor as described in the foregoing.

In addition, tool 100 may be used to remove metal, hollow style wall anchors even if the anchor is collapsed. To straighten the collapsed anchor, probe 155 may be inserted into the anchor and the user may hit hammer/hand plate 150 with a hammer or his/her hand to straighten the anchor for easier removal. Alternately, if a screw remains in the anchor, hammer/hand plate indention 150 may be placed against the head of the screw and apply force until the anchor is straightened for the lighter duty anchors. Then bite 125 or threading 130 may be used to pry or twist the anchor from the wall. Once the anchor is removed, using whatever method appropriate, the domed course grit 165 on the end of handle 150 may be used to aid in the prep work of reaming around the hole for filling without the need for fetching other tools.

Simple CR Laurence screw wall grabber anchors are in a thin knife edge like point, pressed or tapped into the wall, once installed, then drive a screw down the center, the anchor spreads open and anchor is installed. The screw must be removed before the anchor can be removed from the wall by the bite end 125 and tip 130 recover. Once the screw is removed, place the threaded end of tool 130 into the screw hole of the anchor until the bite 125 can be clamped down on the anchor from between the sheetrock, lastly pull anchor straight out.

Wall claw anchors are much like CRL anchors, bladed tip for easy install. Install by pressing or tapping anchor into sheetrock, then drive provided screw into the center of anchor which displaces the tip of the anchor to the side, thus anchoring behind the sheetrock. When it comes to removing anchor, unscrew the provided screw, but not completely. It is then advertised that one may pull on the screw straight out for easy removal. Here I know well that not all humans are equal strength, and I know, not everybody can do something so easily without some kind of discomfort. If needed the anchor recover tool 110 may pry on the screw for easy removal, or with the screw removed from anchor. The tool tip 130 can be inserted and grasped with the bite 125 from between the sheetrock. pinched and pulled 110 when the tool handle end 105 is squeezed.

Lead wood screw anchors are much like plastic conical style anchors. They may be removed by inserting the reverse turn side 130 of the nose end inside the center of the anchor, up to the point when the bite 125 is able to clamp around the rim from between the sheetrock. Once anchor is engaged by nose end 110, a gentle tug will remove anchor from the wall.

Drill toggles are a three piece anchor kit including the screw and is said to replace toggle bolts and hollow wall anchors per the package. These are installed by using an existing hole or by using the anchor as a self-tapping anchor. Using a Phillips™ head screwdriver twisting the anchor with pressure into the wall. Once the anchor is in place make sure the arrow on the face of the anchor is in the downward position, now use the provided screw to engage the two piece anchor. To remove the anchor simply remove the screw with a Phillips™ head screwdriver. Next turn the anchor arrow in the upward most position or 180 degrees using the nose end bite 125 and spiral 130 engaged through the center and outer rim of anchor. Finally, use the back end of the handle with the 9/64 inch probe 155 to insert the anchors center screw hole, and push the sliding end of the anchor lightly to the rearmost position. The anchor is now linear and will remove from the wall using the nose end 130 and bite 125 clamped onto the anchor.

Those skilled in the art will readily recognize, in light of and in accordance with the teachings of the present invention, that tool 100 may be useful in areas other than wall preparation including, but not limited to, plumbing, various gauges, auto repair, HVAC maintenance and repair, carpentry, etc. For example, without limitation, tool 100 may be used to back any threaded cylinder out of female threads. Bite 125 may be used to pry nails or tacks from various surfaces. Tool 100 may also be used similarly to conventional pliers.

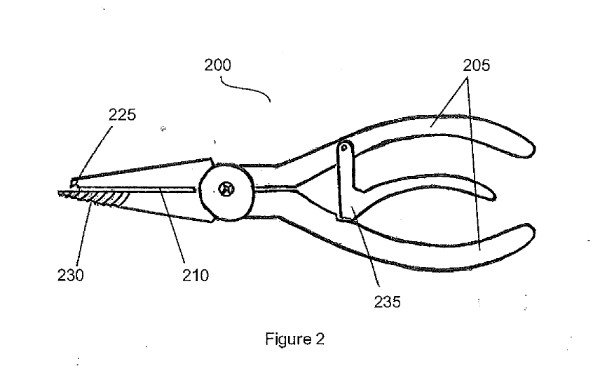

FIG. 2 is a diagrammatic side view of an exemplary wall anchor removal tool 200, in accordance with an embodiment of the present invention. In the present embodiment, anchor removal tool 200 may be implemented with simple handles 205 rather than handles comprising means for achieving additional functionalities. A nose portion 210 may comprise one section with a bite 225 near the tip and another section with left handed threading 230. Bite 225 may be able to get between an anchor and the wall to grasp and pry some types of anchors from a wall. Threading 230 may be inserted into an anchor and twisted to back the anchor out of a wall. In addition, a limiter 235 may be located between handles 205 and may help prevent the sections of nose portion 210 from closing completely so that difficult anchors may be released from tool 200 after removal.

Those skilled in the art will readily recognize, in light of and in accordance with the teachings of the present invention, that Any kit or tools resembling any or all of the characteristics/novelties of the Sheetrock Recover Tool including smaller or larger versions, or slight curved appearances to novelties.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112(1), all claims must be supported by sufficient disclosure in the present patent specification, and any material known to those skilled in the art need not be explicitly disclosed. However, 35 USC § 112(6) requires that structures corresponding to functional limitations interpreted under 35 USC § 112(6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) when such corresponding structures are not explicitly disclosed in the foregoing patent specification. Therefore, for any invention element(s)/structure(s) corresponding to functional claim limitation(s), in the below claims interpreted under 35 USC § 112(6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112(6). Applicant(s) note that all the identified documents above which are incorporated by reference to satisfy 35 USC § 112(6) necessarily have a filing and/or publication date prior to that of the instant application, and thus are valid prior documents to incorporated by reference in the instant application.

Having fully described at least one embodiment of the present invention, other equivalent or alternative methods of implementing a sheetrock anchor extracting tool according to the present invention will be apparent to those skilled in the art. Various aspects of the invention have been described above by way of illustration, and the specific embodiments disclosed are not intended to limit the invention to the particular forms disclosed. The particular implementation of the Anchor Recover Tool 100 may vary depending upon the particular context or application. By way of example, and not limitation, the Anchor Recover Tool 100 described in the foregoing were principally directed to wall anchor implementations; however, similar techniques may instead be applied to slab flooring where plastic conical anchors are used to install thresholds. Plumbing where plastic or metal pipe caps are weathered or corroded. Electrical j boxes where cap hole covers are used may be stripped, a hole would have to be drilled first before tool is applied. It is also up to the holders discretion where the anchor recover tool 100 is applied, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A device comprising:
a handle portion, said handle portion comprising at least a pair of handle implements, said pair of handle implements comprising at least a first handle implement and a second handle implement;
a nose portion configured to extract at least a wall anchor, said nose portion comprising at least a pair of nose portions, wherein said pair of nose portions comprising;
a first nose portion having at least a bite implement disposed at a proximate tip of said first nose portion, wherein a concave portion of said bite implement is operable for clamping on a rim portion of said wall anchor to be removed;
a second nose portion having at least a spiral groove implement, wherein said spiral groove implement is operable for mating with an inside thread of said wall anchor so that said wall anchor can be pulled out of said wall; and
wherein said first nose portion is substantially shorter than said second nose portion; and
a pivot point, wherein said pair of nose portions is configured to close or open around said pivot point.

2. The device of claim 1, further comprising at least a limiter implement that is configured to prevent said pair of nose portions from closing completely;

3. The device of claim 3, further comprising at least a pin, wherein said limiter implement is configured to pivot on said pin, for said limiter implement to be moved into and out of place.

4. The device of claim 3, further comprising a flattened surface, wherein said limiter is operable to rest on said flattened surface.

5. The device of claim 4, wherein said spiral groove implement comprising at least a clockwise spiral grooved thread.

6. The device of claim 5, in which said wall anchor comprising, at least one of, a twist and turn style sheetrock anchor that is right hand installed.

7. The device of claim 1, wherein said spiral groove implement comprising at least a left handed spiral groove thread operable for screwing into said wall anchor.

8. The device of claim 1, wherein said first handle implement comprising a hammer or hand plate, wherein an outside edge of said hammer or hand plate is indented to capture a screw head.

9. The device of claim 8, wherein said first handle implement further comprising a probe with at least one of, a domed tip and a pointed tip disposed at a proximate distal end of said probe, wherein said probe is operable to be inserted into a hollow style wall anchor to straighten the anchor.

10. The device of claim 10, wherein said second handle implement comprising a course grit disposed at a proximate distal end of said second handle implement, in which said course grit is operable for reaming a hole in a wall vacated by said wall anchor.

11. The device of claim 11, wherein said spiral groove implement comprising at least a counter-clockwise spiral grooved thread.

12. The device of claim 11, wherein said wall anchor comprising at least one of, a wall claw anchor, a CRL anchor, a lead wood screw anchor, a plastic conical style anchor a hollow style wall anchor.

13. A device comprising:
means for holding said device;
means for extracting at least a wall anchor;
means for clamping on a rim portion of said wall anchor;
means for mating with an inside thread of said wall anchor so that said wall anchor is pulled out of said wall;
wherein said clamping means is substantially shorter than said mating means.

14. The device of claim 13, further comprising a means for preventing removing means from closing completely.

15. The device of claim 14, further comprising a means for straightening said wall anchor.

16. The device of claim 15, further comprising a means for reaming a hole in a wall vacated by said wall anchor.

17. A device comprising:
a handle portion, said handle portion comprising at least a pair of handle implements, said pair of handle implements comprising at least a first handle implement and a second handle implement;
a nose portion configured to remove at least a wall anchor, said nose portion comprising at least a pair of nose portions, wherein said pair of nose portions comprising;
a first nose portion having at least a bite implement disposed at a proximate tip of said first nose portion, wherein a concave portion of said bite implement is operable for clamping on a rim portion of said wall anchor to be removed;
a second nose portion having at least a spiral groove implement, wherein said spiral groove implement is operable for mating with an inside thread of said wall anchor so that said wall anchor can be pulled out of said wall; and
wherein said first nose portion is substantially shorter than said second nose portion; and
a pivot point, wherein said pair of nose portions is configured to close or open around said pivot point;
in which said wall anchor comprising, at least one of, a twist and turn style sheetrock anchor, a wall claw style anchor, a CRL anchor, a lead wood screw anchor, a plastic conical style anchor, and a hollow style wall anchor.
wherein said spiral groove implement comprising at least a left handed spiral groove thread operable for screwing into said wall anchor.

18. The device of claim 17, further comprising a limiter implement configured to prevent said pair of nose portions from closing completely;

19. The device of claim 18, further comprising a pin, wherein said limiter implement is configured to pivot on said pin to be moved into and out of place.

20. The device of claim 19, further comprising a flattened surface, wherein said limiter is operable to rest on said flattened surface.
